(19) United States
(12) Patent Application Publication
(10) Pub. No.: US 2010/0075839 A1
(43) Pub. Date: Mar. 25, 2010

(54) EXHAUST GAS PURIFICATION CATALYST FOR INTERNAL COMBUSTION ENGINE

(76) Inventors: Hiroshi TANADA, Nagoya-shi (JP); Ken Tanabe, Okazaki-shi (JP)

Correspondence Address: BIRCH STEWART KOLASCH & BIRCH, PO BOX 747, FALLS CHURCH, VA, 22040-0747, US

(21) Appl. No.: 12/564,970

(22) Filed: Sep. 23, 2009

(30) Foreign Application Priority Data
Sep. 24, 2008 (JP) 2008-244243

(51) Int. Cl. B01J 23/10

(52) U.S. Cl. 502/304

(57) ABSTRACT

An exhaust gas purification catalyst includes a catalytic layer constituted by a heap of particles each obtained by applying a thin film of an oxygen storage material containing ceria to the surface of a base made of a material having a high-specific surface area, and allowing a precious metal to be supported on the surface of the thin film of the oxygen storage material.

### BACKGROUND OF THE INVENTION

1. Field of the Invention

The present invention relates to an exhaust gas purification catalyst for use in an internal combustion engine, and more particularly, to techniques of improving the durability of an exhaust gas purification catalyst with an oxygen storage capacity.

2. Description of the Related Art

As conventional exhaust gas purification catalysts for internal combustion engines, three-way catalysts have been widely used which, in general, are capable of removing HC (hydrocarbons) and CO (carbon monoxide) by oxidation and NOₓ (nitrogen oxides) by reduction in an air-fuel ratio region around the stoichiometric ratio (stoich).

Also, in recent years, three-way catalysts containing an OSC material (oxygen storage capacity material) besides the catalyst in order to improve the exhaust purification efficiency have been developed and put to practical use.

By virtue of the function of the OSC material, a three-way catalyst with the OSC material is capable of storing oxygen contained in the exhaust gas in a lean air-fuel ratio region and releasing the stored oxygen in a rich air-fuel ratio region. Accordingly, when the engine is operating with a rich air-fuel ratio and thus the exhaust gas has a rich air-fuel ratio, the three-way catalyst with the OSC can continuously oxidize the produced HC and CO by the oxygen stored in the OSC material. Even in the rich air-fuel ratio region, therefore, HC, CO and NOₓ can be simultaneously removed, whereby the air-fuel ratio window of the three-way catalyst is widened, making it possible to improve the exhaust purification efficiency.

As such OSC material, a compound oxide (CeO₂·ZrO₂) containing ceria (CeO₂) or cerium (Ce) and zirconium (Zr) is commonly known. The three-way catalyst with the OSC has a structure such that a precious metal (Pt or the like) is supported on the surface of particulate ceria or the like.

However, the compound oxide containing ceria or cerium and zirconium is low in heat resistance and is associated with the problem that particle growth occurs due to heat history, entailing a decrease in the surface area and thus in the oxygen storage capacity. Another problem also arises in that, because of the particle growth of ceria (CeO₂), the supported precious metal is buried in the grown particles of ceria or aggregates to cause sintering, lowering the exhaust purification performance itself.

A catalyst has therefore been developed which has a structure such that a precious metal is supported on an alumina carrier (alumina particles) with high heat resistance to restrain sintering of the precious metal, the alumina carrier and the precious metal being coated with a ceria layer (Japanese Laid-open Patent Publication No. H08-131830).

In the catalyst disclosed in the publication, however, the precious metal is also coated with the ceria layer, so that the ceria layer keeps all particles of the precious metal from contacting with the exhaust gas, giving rise to the problem that the exhaust purification performance is low.

Also, since the alumina carrier has an irregular surface, particles of the precious metal caught in the recesses of the alumina carrier may possibly be wholly coated with and buried in the ceria layer, with the result that the recesses are evened out by the ceria layer, causing a drastic decrease in the specific surface area of the catalyst.

### SUMMARY OF THE INVENTION

The present invention was made to solve the above problems, and an object thereof is to provide an exhaust gas purification catalyst for an internal combustion engine, which has high heat resistance and of which the exhaust purification performance can be kept high.

To achieve the object, the present invention provides an exhaust gas purification catalyst for an internal combustion engine. The exhaust gas purification catalyst is arranged in an exhaust passage of the engine to purify an exhaust gas emitted from the engine and is characterized in that a catalytic layer comprises a heap of particles each obtained by applying a thin film of an oxygen storage material containing ceria to a surface of a base made of a material having a high-specific surface area, and allowing a precious metal to be supported on a surface of the thin film of the oxygen storage material.

Since the oxygen storage material containing ceria is applied in the form of a thin film to the surface of the base made of a material with a high-specific surface area, the particle growth of the ceria does not occur irrespective of heat history, thus restraining decrease in the surface area of the ceria.

Accordingly, lowering in the oxygen storage capacity of the oxygen storage material containing ceria can be prevented while minimizing the amount of usage of rare earths such as cerium, which is an expensive rare metal, and it is also possible to avoid a situation where the precious metal supported on the surface of the thin film of the oxygen storage material is buried in the ceria or aggregates to cause sintering.

### BRIEF DESCRIPTION OF THE DRAWINGS

The present invention will become more fully understood from the detailed description given hereinafter and the accompanying drawings which are given by way of illustration only, and thus, are not limitative of the present invention, and wherein:

FIG. 1 illustrates a schematic construction of a system including an exhaust gas purification catalyst of the present invention, applied to an internal combustion engine;

FIG. 2 is an enlarged sectional view of part of a three-way catalytic converter according to the present invention;

FIG. 3 is an enlarged view of a catalytic particle constituting a catalytic layer; and

FIG. 4 illustrates change in oxygen storage capacity of oxygen storage materials with respect to heat endurance time.

### DETAILED DESCRIPTION OF THE INVENTION

An embodiment of the present invention will be described below with reference to the accompanying drawings.

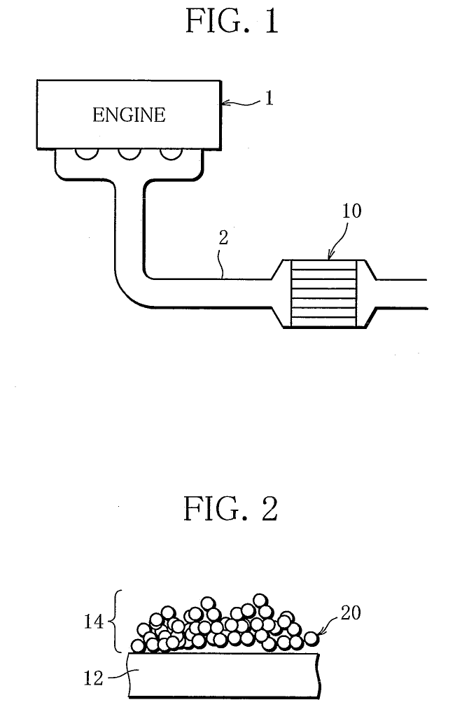

FIG. 1 illustrates a schematic construction of a system including an exhaust gas purification catalyst of the present invention, applied to an internal combustion engine.

An engine 1 is, for example, a spark-ignition gasoline engine, and as illustrated in FIG. 1, a three-way catalytic converter 10 is inserted in an exhaust pipe 2 of the engine 1.

The three-way catalytic converter 10 comprises, as illustrated in FIG. 2 showing a part thereof in section in an enlarged manner, a porous honeycomb support 12 made of cordierite, for example, and a catalytic layer 14 supported on the surface of the support 12. Specifically, the catalytic layer 14 is formed by heaping up catalytic particles 20 each having a catalyst function.

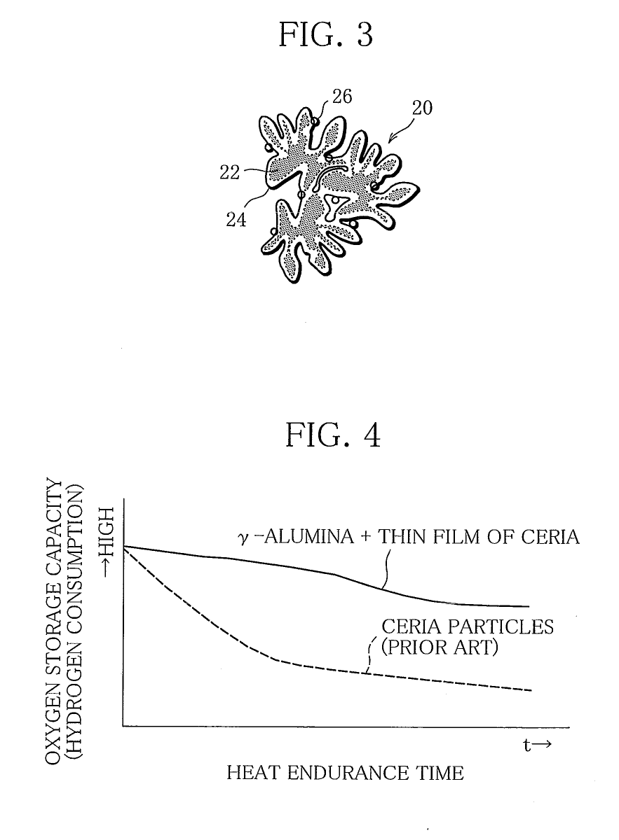

Referring now to FIG. 3 showing a single catalytic particle 20 in more detail, the structure of the catalytic particle 20 will be described.

As illustrated in FIG. 3, the catalytic particle 20 comprises an alumina base 22 made of alumina (Al₂O₃) (material with a high-specific surface area), a thin film of an oxygen storage material 24 applied to the outer surface of the alumina base 22 and containing ceria (CeO₂) with an oxygen storage capacity (OSC), and a particulate precious metal 26 supported on the outer surface of the thin film of the oxygen storage material 24.

In this embodiment, γ-alumina (γ-Al₂O₃) is used as the alumina forming the alumina base 22. Among a plurality of kinds of alumina, the γ-alumina has a relatively large specific surface area, and its specific surface area measured by the BET method commonly known in the art shows a value falling within the range of 100 to 500 m²/g, for example.

Alternatively, θ-alumina (θ-Al₂O₃), which has a slightly different structure from the γ-alumina, may be used instead as the alumina base 22. The specific surface area of the θ-alumina measured by the BET method shows a value also falling within the range of 100 to 500 m²/g, for example. Where an average specific surface area of the θ-alumina is compared with that of the γ-alumina, however, the θ-alumina tends to show a smaller value than the γ-alumina. As for heat resistance, on the other hand, the θ-alumina is capable of maintaining its specific surface area up to higher temperatures than the γ-alumina.

It is also known that the alumina base 22 in general has high heat resistance.

The oxygen storage material 24 is a ceria-zirconia compound oxide containing zirconia (ZrO₂) in addition to ceria (CeO₂) having an oxygen storage capacity. The oxygen storage material 24 constituted by the ceria-zirconia compound oxide is applied in the form of a thin film to the outer surface of the alumina base 22.

The oxygen storage material 24 is prepared, for example, by using an organic complex method as described below.

The organic complex method is a commonly known technique for forming a coating film out of an aqueous solution containing a metal complex with a small molecular weight and alkylamine. Specifically, an aqueous metal chloride solution is mixed with ethylenediaminetetraacetic acid, tributylamine and hydrogen peroxide water to obtain tributylammonium salt, which is a metal complex. The metal complex thus obtained is mixed with ethanol to prepare an organic complex solution. Then, the organic complex solution is applied to the alumina base by continuous-flow curtain coating and baked, whereby a thin metal oxide film is formed over the alumina base.

Accordingly, by using the organic complex method, it is possible to easily form a thin film of the oxygen storage material 24 around the alumina base 22.

Because of the oxygen storage capacity of ceria, the oxygen storage material 24 is capable of storing oxygen contained in the exhaust gas when the exhaust gas has a lean air-fuel ratio, and releasing the oxygen stored therein when the exhaust gas has a rich air-fuel ratio. Thus, when the engine 1 operating with a rich air-fuel ratio and the exhaust gas has a rich air-fuel ratio, the oxygen storage material 24 can continuously remove HC and CO in the exhaust gas by oxidation using the oxygen stored in the ceria. Consequently, even while the exhaust gas has a rich air-fuel ratio, HC, CO and NOₓ can be simultaneously removed, whereby the air-fuel ratio window of the three-way catalytic converter 10 is widened, improving the exhaust purification efficiency.

The thin film of the oxygen storage material 24 has a thickness set in accordance with the specific surface area of, for example, the alumina base 22. Specifically, the larger the specific surface area of the alumina base 22, the finer the irregularities in the surface of the alumina base 22 tend to become. Accordingly, the thickness of the thin film of the oxygen storage material 24 is so set as to decrease with increase in the specific surface area of the alumina base 22. The reason is as follows: As the film thickness of the oxygen storage material 24 is increased, the irregularities in the surface of the alumina base 22 tend to be evened out by the oxygen storage material 24, so that the specific surface area decreases. As a result, the oxygen storage material 24 containing ceria shows a tendency to decrease in its exposed surface area. In order to restrain the occurrence of such a situation, the film thickness of the oxygen storage material 24 is set in accordance with the specific surface area. Preferably, taking into account the decrease in the specific surface area of the alumina base 22, the film thickness of the oxygen storage material 24 is set (e.g., to 100 nm or less) such that the specific surface area of the alumina base 22 (catalytic particle) applied with the oxygen storage material 24 is equal to or larger than 50% of the specific surface area of the alumina base 22 (catalytic particle) not yet applied with the oxygen storage material 24. Where the θ-alumina, instead of the γ-alumina, is used to form the alumina base 22, the film thickness of the oxygen storage material 24 is set greater than in the case where the alumina base 22 is made of the γ-alumina, because on average, the θ-alumina has a smaller specific surface area than the γ-alumina as stated above.

For the precious metal 26, platinum (Pt), palladium (Pd), rhodium (Rh) or the like is used, for example.

The following describes the action and advantageous effects of the exhaust gas purification catalyst constructed as described above.

In the aforementioned exhaust gas purification catalyst of the present invention, the alumina base 22 is made of the γ-alumina having a relatively large specific surface area, the ceria-zirconia compound oxide as the oxygen storage material 24 is applied in the form of a thin film to the outer surface of the alumina base 22, and the precious metal 26 is supported on the surface of the thin film of the oxygen storage material 24.

Since the oxygen storage material 24 is applied in the form of a thin film to the alumina base 22, ceria and zirconia particles remain in the form of a thin film and the ceria particles do not overlie one upon another. Consequently, the particle growth of the ceria etc. does not occur irrespective of heat history, thus restraining decrease in the surface area of the ceria having the oxygen storage capacity.

Also, the alumina base 22 made of the γ-alumina or θ-alumina inherently has a sufficient specific surface area as large as 100 to 500 m²/g, for example. The oxygen storage material 24 can therefore be applied to such a large surface of the alumina base 22, making it possible to increase the surface area of the ceria as large as possible.

In particular, the thin film of the oxygen storage material 24 containing ceria has its thickness set in accordance with the specific surface area of the alumina base 22, and the oxygen storage material 24 is applied in such a manner that decrease in the specific surface area of the alumina base 22 is restrained. For example, the thickness of the thin film of the oxygen storage material 24 is decreased with increase in the specific surface area of the alumina base 22. Accordingly, even in the case where the surface of the alumina base 22 has fine irregularities, the oxygen storage material 24 can be reliably applied in the form of a thin film to the outer surface of the alumina base 22, thus permitting the ceria to have a large surface area.

Consequently, lowering in the oxygen storage capacity of the oxygen storage material 24 can be prevented satisfactorily while minimizing the amounts of cerium and zirconium used, which are expensive rare metals.

FIG. 4 illustrates how the oxygen storage capacities of oxygen storage materials, calculated in terms of the amount of consumption of hydrogen, change with respect to heat endurance time. In the figure, the solid line indicates the case where the ceria-zirconia compound oxide as the oxygen storage material 24 is applied in the form of a thin film to the outer surface of the alumina base 22, and the dashed line indicates a conventional construction wherein ceria particles are merely piled up on the surface of the alumina base. As seen from FIG. 4, where the ceria-zirconia compound oxide is applied in the form of a thin film to the outer surface of the alumina base 22 (solid line), the oxygen storage capacity can be maintained high with respect to the heat endurance time (heat history), as compared with the conventional construction (dashed line).

According to the present invention, the particle growth of ceria having an oxygen storage capacity does not occur, and also decrease in the surface area of the ceria is restrained. It is therefore possible to reliably avoid a situation where the precious metal 26 supported on the surface of the oxygen storage material 24 is buried in the ceria or aggregates to cause sintering.

Thus, the present invention makes it possible to provide an excellent exhaust gas purification catalyst which has high heat resistance and of which the exhaust purification performance can be kept at a high level.

While the exhaust gas purification catalyst according to the present invention has been described, it is to be noted that the present invention is not limited to the foregoing embodiment alone.

For example, in the above embodiment, a ceria-zirconia compound oxide containing ceria (CeO₂) and zirconia (ZrO₂) is used as the oxygen storage material 24, but the oxygen storage material 24 is not limited to this compound oxide. The oxygen storage material 24 may alternatively be made of a ceria-zirconia-yttria compound oxide containing ceria

(CeO₂), zirconia (ZrO₂) and yttria (Y₂O₃), or a ceria-zirconia-lanthanum oxide compound oxide containing ceria (CeO₂), zirconia (ZrO₂) and lanthanum oxide (La₂O₃), for example.

What is claimed is:

1. An exhaust gas purification catalyst for an internal combustion engine, the exhaust gas purification catalyst being arranged in an exhaust passage of the engine to purify an exhaust gas emitted from the engine, wherein
a catalytic layer comprises a heap of particles each obtained by applying a thin film of an oxygen storage material containing ceria to a surface of a base made of a material having a high-specific surface area, and allowing a precious metal to be supported on a surface of the thin film of the oxygen storage material.

2. The exhaust gas purification catalyst according to claim 1, wherein
the base has a specific surface area of 100 to 500 m²/g.

3. The exhaust gas purification catalyst according to claim 1, wherein
the base is made of one of γ-alumina and θ-alumina.

4. The exhaust gas purification catalyst according to claim 1, wherein
the thin film of the oxygen storage material containing ceria has a film thickness set in accordance with the specific surface area of the base.

5. The exhaust gas purification catalyst according to claim 1, wherein
each of the particles applied with the oxygen storage material has a specific surface area equal to or larger than 50% of the specific surface are of the base not applied with the oxygen storage material.
